(19) United States
(12) Patent Application Publication
(10) Pub. No.: US 2006/0242654 A1
(43) Pub. Date: Oct. 26, 2006

(54) Process and apparatus for sharing inline caches

(76) Inventors: Kasper Verdich Lund, Hoejbjerg (DK); Lars Bak, Tranbjerg J. (DK); Jakob Roland Andersen, Hoejbjerg (DK); Steffen Grarup, Hoejbjerg (DK)

Correspondence Address: PERKINS COIE LLP, P.O. BOX 2168, MENLO PARK, CA, 94026, US

(21) Appl. No.: 11/112,967

(22) Filed: Apr. 22, 2005

(51) Int. Cl. G06F 9/44

(52) U.S. Cl. 719/331

(57) ABSTRACT

A technique for dynamic dispatch involves adapting a method at a dispatch point to reference a state cache. State of the state cache may be associated with an object type and a method signature. When a method is adapted at the dispatch point to reference a state cache, the reference is to a state cache associated with a state that matches the method signature and the object type of the object dispatched upon. The state cache may be shared among multiple methods with similar associated states to reduce memory requirements.

### BACKGROUND

The present invention relates to digital processing systems. More specifically, the invention relates to dynamic dispatch in digital processing systems.

Objects, in object-oriented systems, are data structures that encapsulate data and methods that operate on that data. Classes define types of objects. Objects are instances of classes. Methods define actions the class can perform. Classes can be organized into a hierarchy that includes a parent class at the root. Children of the parent class may inherit methods and data from the parent, redefine methods and data, or introduce new methods and data. The hierarchy can grow to arbitrary complexity. Methods may be distinguished by using a method signature that includes the combination of the method's name and the number, type, and order of parameters. The method signature may also include, for example, a visibility modifier (e.g., public, private, protected), a return type, a throws clause, or some other value. To invoke a method, a message is sent to an object, which selects the method to execute. The method address may be found at runtime through a technique known as dynamic dispatch. Dynamic dispatching typically entails extracting the data type (class) of the object and mapping the method signature to a method address. The inheritance property of classes occasionally makes method-lookup somewhat complicated. If a method-lookup fails, the method-lookup is repeated at the parent of the object's class, continuing up the class hierarchy until the method-lookup succeeds or the root of the hierarchy is reached.

Inline caching of method addresses is first described by Deutsch and Shiffinan in “Efficient Implementation of the Smalltalk-80 System,” Conference Record of the Eleventh Annual ACM Symposium on Principles of Programming Languages, pp. 297-302, Salt Lake City, Utah, 1984, which is incorporated herein by reference in its entirety. In accordance with the inline caching technique, when the method-lookup succeeds, a direct call to the class's method may be written into computer code at the dispatch point (e.g., the point from which the method call was made). Subsequent method calls may be more efficient since method-lookup can be avoided as long as the objects dispatched upon have the same type. Unfortunately, cache size adversely impacts the memory requirements of programs.

Dynamic dispatching is a process of invoking a method on an object, where the method address is determined (deterministically) at runtime by the signature of the method and dynamic type (e.g., class) of the object. Once the method is known, computer code associated with the called method may be written into the computer code at the dispatch point. Subsequent invocations of the method are more efficient because the computer code associated with the method is at the dispatch point (inline caching). However, this efficiency comes at the expense of increased memory usage.

### SUMMARY

A technique for optimizing dynamic dispatch in object oriented systems includes inline caching. In one embodiment of the invention, an inline cache includes an inline reference to a called method. The inline reference may be direct or indirect. For example, the inline reference may be directed to a cache state. The cache state may include the called method address and the prerequisite type used for cache validation. In an alternative embodiment, the cache state may itself include an inline cache.

The memory requirements of the inline reference and the cache state may not be significantly less than the memory requirements associated with an inline cache (and could even be more). However, if multiple cache states share certain characteristics, such as, for example, identical cached method addresses and prerequisite types, each inline reference can be directed to the same cache state. Assuming the number of distinct cache states is less than the number of distinct dispatch points, the use of an inline reference should reduce memory requirements.

### BRIEF DESCRIPTION OF THE DRAWINGS

Embodiments of the invention are illustrated in the figures. However, the embodiments and figures are illustrative rather than limiting; they provide examples of the invention.

FIGS. 1A, 1B, and 1C depict diagrams intended to illustrate adapting a method to include an inline reference to a cache state according to an embodiment;

FIG. 2 depicts a conceptual view of calling methods and called methods according to an embodiment;

FIGS. 3A and 3B depict diagrams intended to illustrate method validation according to an embodiment.

FIG. 4 depicts a flowchart of a process according to an embodiment;

FIG. 5 depicts a flowchart of a process according to another embodiment;

FIGS. 6A, 6B, and 6C depict diagrams intended to illustrate adapting a method to include an inline reference to a cache state according to another embodiment;

FIG. 7 depicts a networked system for use in an embodiment; and

FIG. 8 depicts a computer system for use in the system of FIG. 7.

### DETAILED DESCRIPTION OF EMBODIMENTS

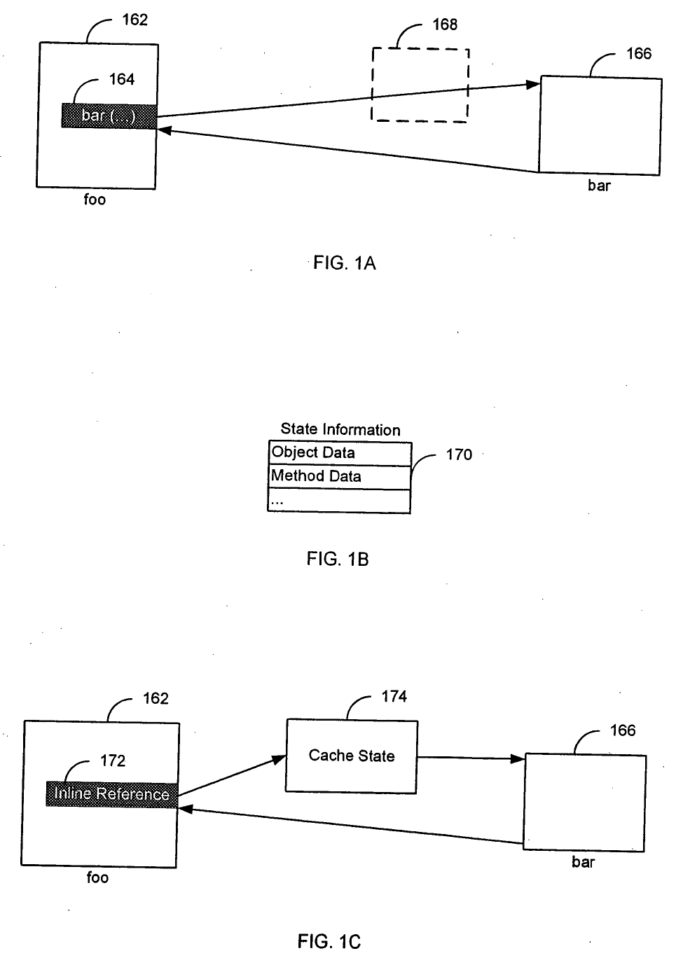

FIGS. 1A to 1C depict diagrams intended to illustrate adapting a method to include an inline reference to a cache state according to one embodiment. FIG. 1A depicts a method 162 that includes computer code 164 associated with a method call to a method 166. It should be noted that this association may be via dynamic dispatch, rather than a fixed call to the method 166. The method 162 is labeled “foo,” which is a commonly ascribed name for methods, functions, procedures, routines, etc. in the art of computer programming. The method 166 is labeled “bar,” which is another commonly ascribed name for methods et al. The computer code 164 associated with the method call to the method 166 may be compiled during compile time (turning the computer code into, for example, a binary file). The computer code could also be interpreted at runtime. For the sake of illustrative simplicity, the computer code 164 is referred to as “computer code” regardless of any compiling, interpreting, or other modifications that may be taken to change the computer code from one form to another.

In operation, when the method 162 executes commands associated with the computer code 164 to call the method 166, the point at which the method 162 calls the method 166 may be referred to as a dispatch point. The dispatch point is represented in FIG. 1A as the beginning point of the arrow pointing from the method 162 to the method 166. The starting point of the method 166, represented in FIG. 1A as the ending point of the arrow pointing from the method 162 to the method 166, may be referred to as an enter point.

In operation, the method 166, once called, executes one or more commands. When the method 166 is done executing, the method 166 passes control back to the calling method 162. The point at which the method 166 finishes may be referred to as an exit point. The exit point is represented in FIG. 1A as the beginning point of the arrow pointing from the method 166 to the method 162. There may be multiple potential exit points in the method 166 (not shown) and there may be one or more calls to additional methods (not shown).

In an embodiment, a state acquisition engine 168 intercepts the method call from the method 162 to the method 166. Method-call interception (MCI) is a well-known technique for facilitating runtime adaptation for object-oriented software systems. Since the technique is well-known, MCI is not described in detail herein.

The state acquisition engine 168 determines state information, which may include, for example, object data, method data, and other data. In an embodiment, the other data may include data associated with environment variables or other parameters. The state acquisition engine 168 may perform method-lookup using the method signature at the dispatch point 164 and the type of object dispatched upon to find a method address.

Calls from the method 162 to the method 166 may be local. For example, methods 162 and 166 may be stored locally in non-volatile storage or memory. In an alternative, calls from the method 162 may extend from a remote computer location to or from, for example, a server computer across a LAN or other network.

FIG. 1B is intended to illustrate state information 170. For exemplary purposes, the state information 170 includes object data and method data. The object data may include, for example, the object type of the object dispatched upon. The method data may include, for example, the method signature at the dispatch point (e.g., at computer code 164).

While there is no specific requirement as to the format of the state information 170, the state information should be sufficient to map the method signature for the object type of the object dispatched upon to a method address. Advantageously, this can make method-lookup unnecessary for subsequent method calls, so long as the state information remains valid. In an embodiment, the object type may be referred to as associated with the method 166. The method 166 may or may not be encapsulated within an object having the object type with which the method 166 is associated. In another embodiment, the method 166 may or may not be inherited by the object having the object type. In another embodiment, the method 162 could also be associated with the object type.

FIG. 1C is intended to illustrate how the calling method (method 162) is adapted to take advantage of the state information. The method 162 is adapted by replacing the computer code 164 with an inline reference 172. The inline reference 172 may be referred to as an inline cache, but, in an embodiment, the inline cache includes only the inline reference to a cache state 174.

The cache state 174 calls the method 166. After the method 162 is adapted, the inline reference 172 may be referred to as the dispatch point for the method 162. The enter and exit points of the method 166 are unchanged. The cache state 174 is interposed between the dispatch point of the method 162 and the enter point of the method 166.

Data from the cache state 174 could be incorporated into the method 162 as an inline cache. However, in an object-oriented system, the number of cache states is typically less than the total number of dispatch points. Accordingly, if data from each of the cache states is written into each method at each of the dispatch points, memory resources must be allocated for this purpose. An inline reference to a shared cache state can ameliorate these memory resource requirements.

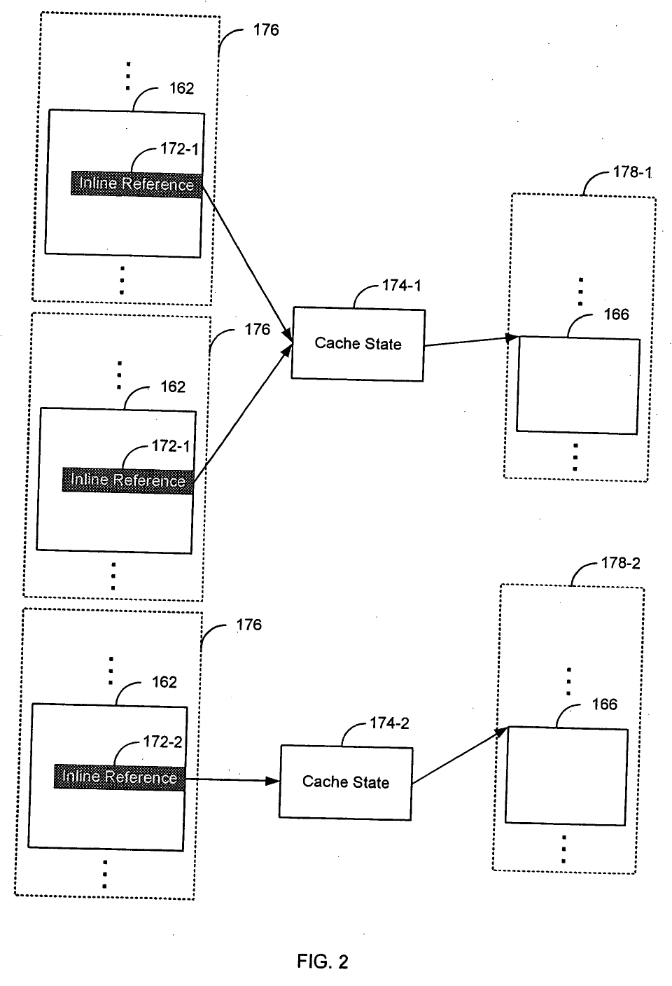

FIG. 2 depicts a conceptual view of calling methods (the methods 162) and called methods (the methods 166) according to an embodiment. In FIG. 2, dashed boxes represent objects 176 and 178, which may respectively encapsulate the methods 162 and 166. In an alternative embodiment, the objects 176 and 178 do not encapsulate the methods 162 and 166. The dashed boxes are dashed so as to illustrate an association without too strongly implying that the objects 176 and 178 must actually encapsulate the methods 162 and 166.

In the example of FIG. 2, methods 162 may include inline references that are directed to an appropriate cache state. Though the methods 166 may or may not initially have identical method signatures, the inline references 172-1 and 172-2 are different because the state information, presumably, indicated that the objects dispatched upon were of different types. As described with reference to FIGS. 1A to 1C, cache states may differ depending upon, for example, method signature and the type of object dispatched upon.

In the example of FIG. 2, for illustrative purposes, the objects 178-1 and 178-2 are assumed to be of different types. Accordingly, the inline reference 172-1 is directed to a state cache 174-1 for an object type associated with the object 178-1. Similarly, the inline reference 172-2 is directed to a state cache 174-2 for an object type associated with the object 178-2.

In operation, when a method 162 reaches the dispatch point, the inline reference directs the method 162 to the appropriate cache state. Since the computer code at the dispatch point has already been adapted to direct the method 162 to the appropriate cache state, no method-lookup is required at the dispatch point.

In an embodiment, the object dispatched upon may change. In this embodiment, some form of method validation may be conducted before invoking the method 166. Method validation may, for example, include checking the object dispatched upon to ensure that the object type is the same as the object type associated with the cache state. If the object type of the object dispatched upon and the object type associated with the cache state are different, the inline reference may be changed to reference a more appropriate cache state. If, on the other hand, the object type of the object dispatched upon and the object type associated with the cache state match, then the method 166 can be invoked without a method lookup.

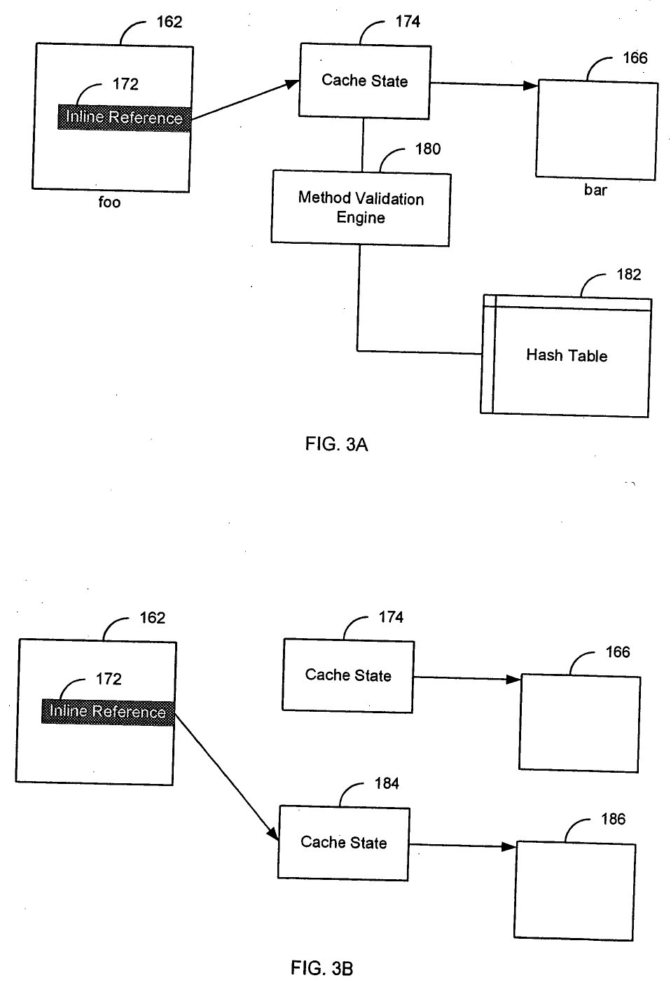

FIGS. 3A and 3B depict diagrams intended to illustrate method validation according to an embodiment. FIG. 3A is similar to FIG. 1C, but a method validation engine 180 and a hash table 182, which may be a global hash table, are coupled to the cache state 174. In an embodiment, the state of the object dispatched upon may be different during a first method call and a second method call. Accordingly, it may be necessary to determine whether state has changed.

In an embodiment, in operation the method validation engine 180 checks the cache state 174 each time a method call is initiated from the dispatch point of a calling method 162. For example, the method validation engine 180 may check the object type of the object dispatched upon and compare the object type to the object type associated with the cache state 174. If the object types match then, at least in this example, the method is validated and the called method 166 is invoked from the cache state 174. If the object types do not match, then the method call is not validated.

In this embodiment, when the method validation engine 180 determines that a method call is not validated, the method validation engine 180 may consult the hash table 182 to find a cache state that is valid for the method call. Cache states may be represented as entries in the hash table 182. The hash code of the hash table 182 may be a function of a method signature and object type. The method validation engine 180 can determine the method signature from, for example, the method call from the method 166.

In an embodiment, the method validation engine 180 can determine object type from, for example, the object dispatched upon. Accordingly, the method validation engine 180 can calculate the hash code and use the hash code to obtain a valid mapping of the method signature and the object type to a target cache state, if the target cache state exists in the hash table 182. If the method validation engine 180 cannot determine the target cache state using, for example, the hash table 182, then a new cache state may be created in a manner similar to that described with reference to FIGS. 1A to 1C.

When the method validation engine 180 knows a valid cache state by, for example, finding the valid cache state in the hash table 182 or by creating a new cache state, the inline reference 172 can be changed to reference the valid cache state. FIG. 3B is intended to illustrate the inline reference 172 referencing a new cache state 184.

As illustrated in FIG. 3B, the inline reference 172 is directed to the new cache state 184. The new cache state 184 is associated with a new method 186. In an embodiment, the method 166 and the new method 186 may be associated with similar object types. In another embodiment, the method 166 and the new method 186 may be similar methods.

In an embodiment, when a cache has no methods pointing to it, the cache may be deleted. For example, if the inline reference 172 in FIG. 3A was the only pointer to the cache state 174, when the inline reference 172 is redirected to the cache state 184 in FIG. 3B, a cleanup procedure may be executed to cleanup or delete the cache state 174. If, on the other hand, other inline references (not shown) remain pointed toward the cache state 174, the cache state 174 would not, in this embodiment, be deleted. In an alternative, cleanup may include removing caches that meet certain criteria.

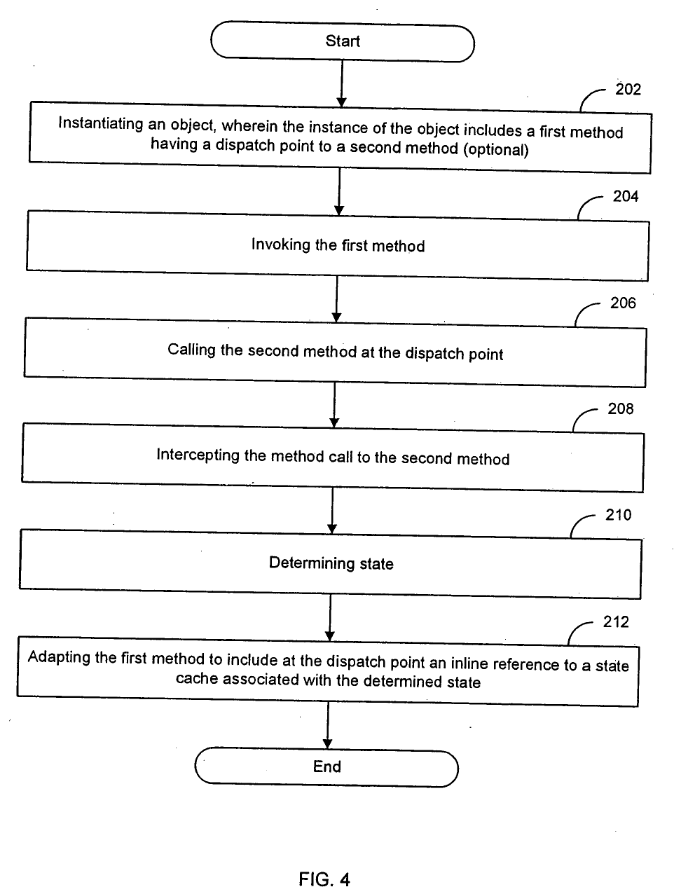

FIG. 4 depicts a flowchart of a process according to an embodiment. The flowchart is intended to illustrate instantiation of an object and subsequent runtime adaptation of a method associated with the object. This process and other processes are depicted as serially arranged modules. However, modules of the processes may be reordered, or arranged for parallel execution as appropriate.

In this embodiment, the flowchart starts at optional module 202 with instantiating an object, wherein the instance of the object includes a first method having a dispatch point to a second method. The object may be instantiated from a class. The class from which the object is instantiated may determine the object type associated with the object. In an embodiment, the instantiation of the object is optional. For example, the first method may or may not be included in an instantiated object.

In the example of FIG. 4, the flowchart continues at module 204 with invoking the first method and at module 206 with calling the second method at the dispatch point. The flowchart continues at module 208 with intercepting the method call to the second method and at module 210 with determining state. The method-call interception (MCI) may be for the purposes of determining state.

In an embodiment, state may include an object type associated with the second method. In another embodiment, the object type may be associated with the object encapsulating the first method. In another embodiment, the object type may be associated with an object to which a method call is directed. In another embodiment, the object type may be associated with an object from which the method call is derived.

In addition, the state may include a method signature associated with the method-call. In an embodiment, the method signature may be determined from the first method. For example, the first method may include computer code intended to invoke the second method that includes a method name, method parameters, and defines types for the parameters. This data may be used to determine a method signature.

In this embodiment, the flowchart ends at module 212 with adapting the first method to include at the dispatch point an inline reference to a state cache associated with the determined state.

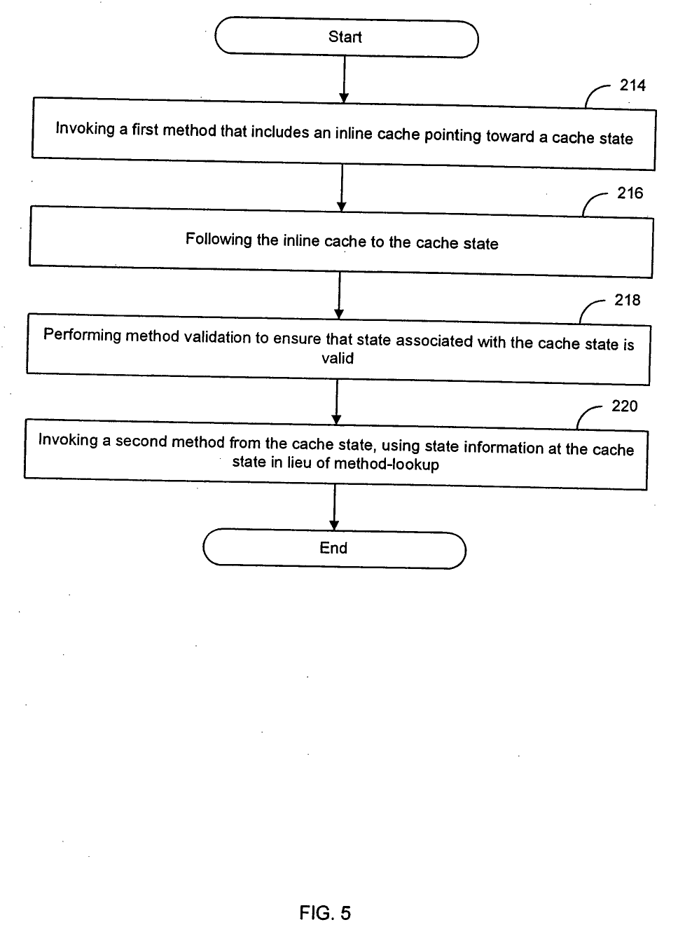

FIG. 5 depicts a flowchart of a process according to an embodiment. FIG. 5 is intended to illustrate invocation of the second method after the first method has been adapted as described, for example, with reference to FIG. 4.

In this embodiment, the flowchart begins at module 214 with invoking a first method that includes an inline cache pointing toward a cache state. In an embodiment, the inline cache may include only an inline reference directed to the cache state. In an alternative embodiment, the inline cache may include, for example, an inline reference directed to the cache state.

In this embodiment, the flowchart continues at module 216 with following the inline cache to the cache state. Following the inline cache may involve, for example, following an inline reference.

In this embodiment, the flowchart continues at module 218 with performing method validation to ensure that state associated with the cache state is valid. Performing method validation is not necessary if state does not change. However, it is possible that state will change between the time the method call is made a first time (and state is cached) and the time the method call is made a second time. For the purposes of example in FIG. 5, it is assumed that the cache state is valid.

In this embodiment, the flowchart ends at module 220 with invoking a second method from the cache state. The cache state may make a method call to the second method. The cache state may include a method signature associated with the second method for, for example, an object type. The object type associated with the cache state may be similar to the object type associated with the second method. In an embodiment, the object types are associated with objects instantiated from identical classes.

In another embodiment, the object types are associated with objects instantiated from related classes. For example, a first class may be a parent that encapsulates the second method and the second class may be a child that inherits the second method. When object types are referred to as being “similar,” this is intended to mean the object types are associated with either identical classes or related classes. In an embodiment where the object types are always associated with identical classes, the object types may still be referred to as similar.

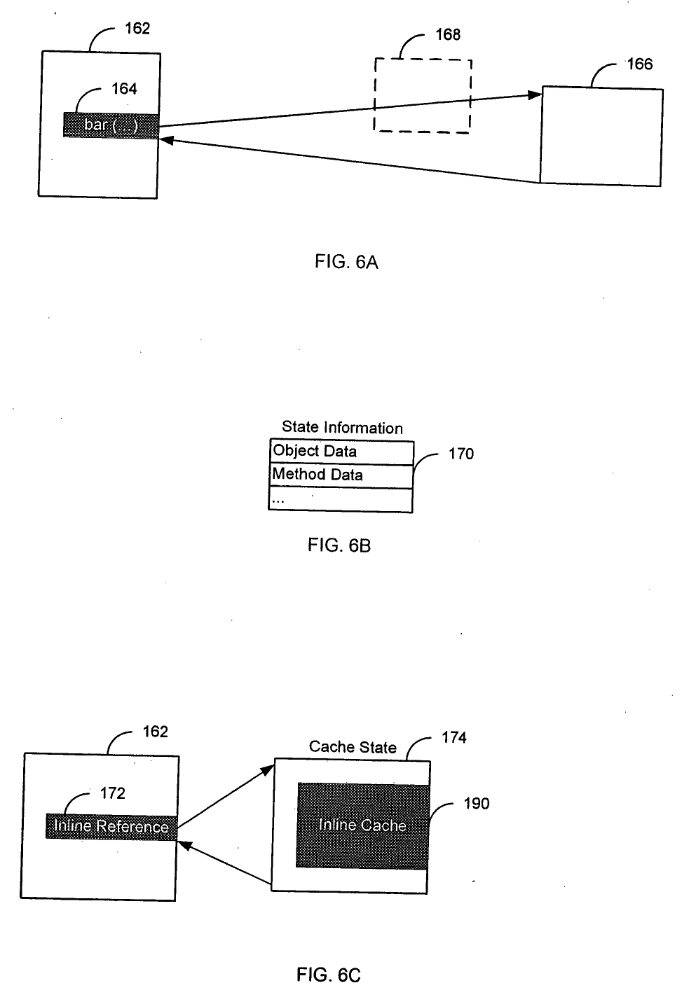

In another embodiment, the cache state may include an inline cache that has computer code associated with the second method, as described with reference to FIGS. 6A to 6C. FIGS. 6A to 6C depict diagrams intended to illustrate adapting a method to include an inline reference to a cache state according to an embodiment. FIGS. 6A and 6B are similar to FIGS. 1A and 1B, described previously, so a description of FIGS. 6A and 6B has been omitted.

FIG. 6C is intended to illustrate how the calling method (method 162) is adapted to take advantage of the cached state information. The method 162 is adapted by replacing the computer code 164 with an inline reference 172 to the cache state 174. The cache state 174 includes state information and an inline cache 190. The inline cache 190 may include computer code associated with the second method 166. The cache state 174 may invoke the second method 166 by executing the computer code included in the inline cache 190.

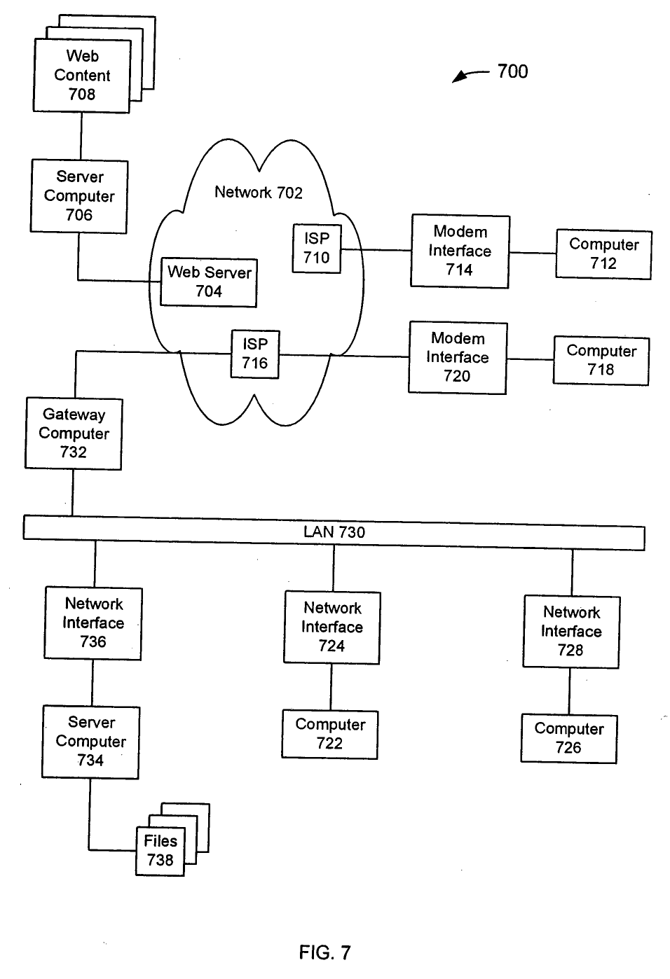

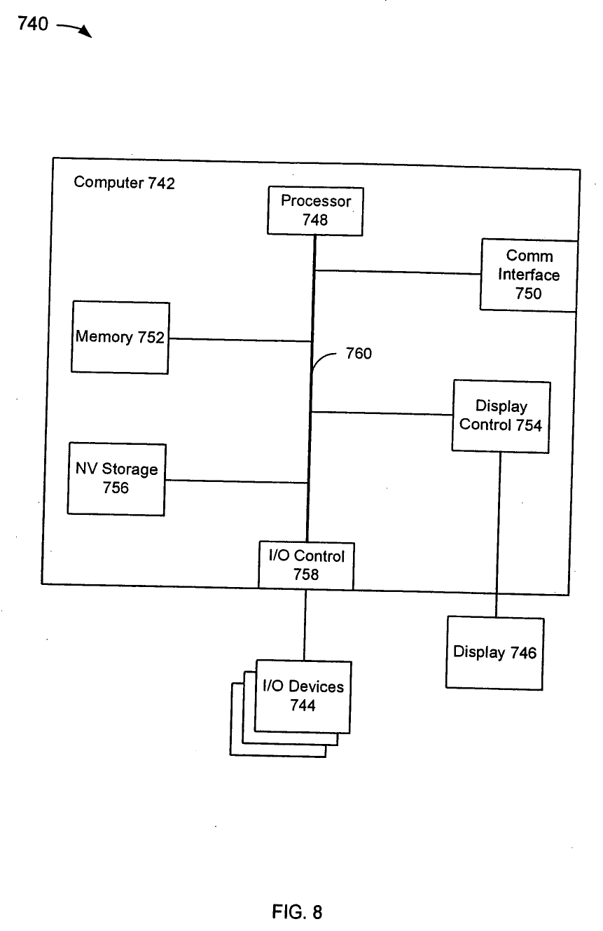

The following description of FIGS. 7 and 8 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 depicts a networked system 700 that includes several computer systems coupled together through a network 702, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 704 is typically at least one computer system which operates as a server computer system and is configured to operate with the protocols of the world wide web and is coupled to the Internet. The web server system 704 can be a conventional server computer system. Optionally, the web server 704 can be part of an ISP which provides access to the Internet for client systems. The web server 704 is shown coupled to the server computer system 706 which itself is coupled to web content 708, which can be considered a form of a media database. While two computer systems 704 and 706 are shown in FIG. 7, the web server system 704 and the server computer system 706 can be one computer system having different software components providing the web server functionality and the server functionality provided by the server computer system 706, which will be described further below.

Access to the network 702 is typically provided by Internet service providers (ISPs), such as the ISPs 710 and 716. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being “on” the Internet. Often these web servers are provided by the ISPs, such as ISP 710, although a computer system can be set up and connected to the Internet without that system also being an ISP.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. The client computer system can be a personal computer system, a network computer, a web TV system, or other computer system. While FIG. 7 shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can be ethernet network or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730 through a network interface 736 to provide files 738 and other services to the clients 722 and 726, without the need to connect to the Internet through the gateway system 732.

FIG. 8 depicts a computer system 740 for use in the system 700 (FIG. 7). The computer system 740 may be a conventional computer system that can be used as a client computer system or a server computer system or as a web server system. Such a computer system can be used to perform many of the functions of an Internet service provider, such as ISP 710 (FIG. 7).

In the example of FIG. 8, the computer system 740 includes a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. The communications interface can be an analog modem, isdn modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor. The memory 752 is coupled to the processor 748 by a bus 760. The memory 752 can be dynamic random access memory (dram) and can also include static ram (sram). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with conventional well known technology.

The non-volatile storage 756 is often a magnetic hard disk, an optical disk, or another form of storage for large amounts of data. Some of this data is often written, by a direct memory access process, into memory 752 during execution of software in the computer 742. One of skill in the art will immediately recognize that the terms “machine-readable medium” or “computer-readable medium” includes any type of storage device that is accessible by the processor 748 and also encompasses a carrier wave that encodes a data signal.

Objects, methods, inline caches, cache states and other object-oriented components may be stored in the non-volatile storage 756, or written into memory 752 during execution of, for example, an object-oriented software program. In this way, the components illustrated in, for example, FIGS. 1-3 and 6 can be instantiated on the computer system 740.

The computer system 740 is one example of many possible computer systems which have different architectures. For example, personal computers based on an Intel microprocessor often have multiple buses, one of which can be an I/O bus for the peripherals and one that directly connects the processor 748 and the memory 752 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 752 for execution by the processor 748. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

While this invention has been described by way of example in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

What is claimed is:

1. A system, comprising:
an object, including a first method with an inline reference;
a state cache configured to invoke a second method, wherein when the first method is invoked the inline reference references the state cache, which invokes the second method.

2. The system of claim 1, said object further comprising an inline cache, wherein the inline cache includes the inline reference.

3. The system of claim 1, said state cache further comprising an inline cache having computer code associated with the second method.

4. The system of claim 1, further comprising a hash table of existing cache states.

5. The system of claim 4, wherein the hash table has a hash function of a class type and a signature of a method.

6. The system of claim 4, wherein the object is a first object, further comprising a second object without an inline reference, wherein the hash table is used to speed up dynamic dispatches for the second object.

7. The system of claim 1, wherein the object is a first object, further comprising a second object without an inline reference, wherein the second object invokes methods on objects of variable types.

8. The system of claim 1, further comprising a plurality of state caches, including the state cache, and a plurality of objects, including the object, wherein the number of cache states is less than the number of inline references.

9. A system comprising:
a state cache, associated with an object type;
a plurality of methods with respective inline references to the state cache, wherein when a calling method of the plurality of methods is invoked, the calling method uses the inline reference to reference the state cache, which invokes a called method associated with the object type.

10. A process, comprising:
instantiating an object, wherein the instance of the object includes a first method having a dispatch point to a second method;
invoking the first method;
calling the second method at the dispatch point;
intercepting the method call to the second method;
determining state;
adapting the first method to include at the dispatch point an inline reference to a state cache associated with said state.

11. The process of claim 10, wherein said state is associated with an object type and a method signature, and wherein said object has the object type and the first method has the method signature.

12. The process of claim 10, further comprising:
creating the state cache; and
associating the state cache with the second method.

13. The process of claim 10, further comprising:
searching existing state caches for the state cache, wherein each of the existing state caches is associated with a different state.

14. A process, comprising:
invoking a first method that includes an inline cache pointing toward a cache state;
following the inline cache to the cache state;
invoking a second method from the cache state.

15. The process of claim 14, wherein the inline cache includes only a reference to the cache state.

16. The process of claim 14, further comprising performing method validation to ensure that state associated with the cache state is valid.

17. The process of claim 14, wherein the inline cache is a first inline cache, further comprising:
invoking a third method that includes a second inline cache pointing toward said cache state;
following the second inline cache to the cache state;
calling the second method from the cache state.

18. The process of claim 14, further comprising initializing the first method by including the inline cache.

19. The process of claim 14, wherein the inline cache is at a dispatch point, further comprising returning to the first method after the dispatch point.

20. The process of claim 14, wherein the cache state is a first cache state, further comprising:
determining state; and
updating the inline cache to point toward a second cache state according to the determined state.
